(19) United States
(12) Patent Application Publication
(10) Pub. No.: US 2008/0218467 A1
(43) Pub. Date: Sep. 11, 2008

(54) BACKLIGHT CONTROLLER AND SCALING FACTOR USING FULL RANGE SEARCH AND LOCAL RANGE SEARCH METHOD

(75) Inventor: Ling-Shiou Huang, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 11/681,870

(22) Filed: Mar. 5, 2007

(51) Int. Cl. G09G 3/36

(52) U.S. Cl. 345/102

(57) ABSTRACT

A backlight controller generating a scaling factor for scaling the intensity of a backlight illuminating a LCD (LCD) is provided. The backlight controller includes a histogram generator and a scaling factor selector. The histogram generator generates a histogram in response to an input frame image of the LCD. The scaling factor selector includes a luminance distortion estimator and a loop controller. The luminance distortion estimator estimates a luminance distortion for each candidate scaling factor with reference to the histogram. The loop controller selects a scaling factor among the corresponding to a maximum acceptable distortion among the estimated luminance distortions, so as to scale the intensity of the backlight.

### BACKGROUND OF THE INVENTION

1. Field of the Invention

The invention relates in general to a backlight controller, and more particularly to a backlight controller capable of scaling backlight luminance with reference to a histogram of the grey level of a frame signal inputted to a liquid crystal display (LCD).

2. Description of the Related Art

Liquid crystal display (LCD) has been widely used in electronic display products such as TV, computer monitor, notebook computer, mobile phone, or persona digital assistant (PDA). An LCD includes a backlight module and an LCD panel. The backlight module provides the backlight with fixed luminance to pass the LCD panel. In the LCD panel, the rotation angle of the liquid crystal molecules displays a frame image by controlling the penetration of the backlight.

In a conventional LCD, the intensity of the backlight is fixed. When the LCD wants to display a dark or black frame image, the liquid crystal molecules cover the backlight via the rotation angle of the liquid crystal molecules, so as to display the dark or the black frame image. However, the continual generation of backlight increases the power consumption by the backlight module and reduces the lifespan of the long operating backlight module. Moreover, as the liquid crystal molecules can not completely cover the backlight, the conventional LCD has lower contrast ratio when displaying a dark or the black frame image, resulting in poor display quality.

### SUMMARY OF THE INVENTION

The invention is directed to a backlight controller and a method thereof capable of overcoming the disadvantages of a conventional liquid crystal display (LCD) backlight module such as more power consumption, and shorter lifespan, lower contrast ratio when displaying dark or black frame image, and poor display quality, and making the backlight module using the backlight controller of the invention have lower power consumption, longer life-span, better LCD contrast ratio and better quality of frame image.

According to a first aspect of the present invention, a backlight controller generating a scaling factor for scaling the intensity of a backlight illuminating a LCD (LCD) is provided. The backlight controller includes a histogram generator and a scaling factor selector. The histogram generator generates a histogram in response to an input frame image of the LCD. The scaling factor selector includes a luminance distortion estimator and a loop controller. The luminance distortion estimator estimates a luminance distortion for each candidate scaling factor with reference to the histogram. The loop controller selects a scaling factor corresponding to a maximum acceptable distortion among the estemated luminance distortions, so as to scale the intensity of the backlight.

According to a second aspect of the present invention, a full range search method for searching a scaling factor is provided. The full range search method searching a scaling factor for scaling the intensity of a backlight illuminating a LCD (LCD) includes the following steps. Firstly, a histogram is generated in response to an input frame signal of the LCD. Next, a luminance distortion is estimated with reference to the histogram for each candidate scaling factor. The candidate scaling factor includes an absolute upper limit, an absolute lower limit and all the numeric ranging between the absolute upper limit and the absolute lower limit. Afterwards, a scaling factor corresponding to a maximum acceptable luminance distortion among the luminance distortions is selected to scale the intensity of the backlight.

According to a third aspect of the present invention, a local range search method for searching a scaling factor is provided. The local range search method searching a scaling factor for scaling the intensity of a backlight illuminating a LCD (LCD) includes the following steps. Firstly, a histogram is generated in response to an input frame signal of the LCD. Next, the previous scaling factor is received. Then, a luminance distortion is estimated with reference to the histogram for each candidate scaling factor. The candidate scaling factor includes all the numeric range near the previous scaling factor. Afterwards, a scaling factor corresponding to a maximum acceptable luminance distortion among the luminance distortions is selected to scale the intensity of the backlight.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a LCD using a backlight controller according to a first embodiment of the invention;

FIG. 2 is a block diagram of a backlight controller according to a first embodiment of the invention;

FIG. 3 is a histogram of each pixel grey level of a frame signal FS (N) of FIG. 1;

FIG. 4 is a correspondence curve of pixel grey level between the frame signals FS (N) and FSβ (N) of FIG. 1;

FIG. 5 is a correspondence curve between pixel grey level of the frame signal FS (N) of FIG. 1 and corresponding luminance error;

FIG. 6 is a correspondence curve between distortion Dβ′ and candidate scaling factor β′ of FIG. 1;

FIG. 7 is a flowchart of full range search method for searching a scaling factor β (N) according to a first embodiment of the invention;

FIG. 8 is a block diagram of a backlight controller according to a second embodiment of the invention;

FIG. 9 is a correspondence curve between distortion Dβ′ and candidate scaling factor β′ of FIG. 8; and

FIG. 10 is a flowchart of local range search method for searching a scaling factor β (N) according to a second embodiment of the invention.

### DETAILED DESCRIPTION OF THE INVENTION

### First Embodiment

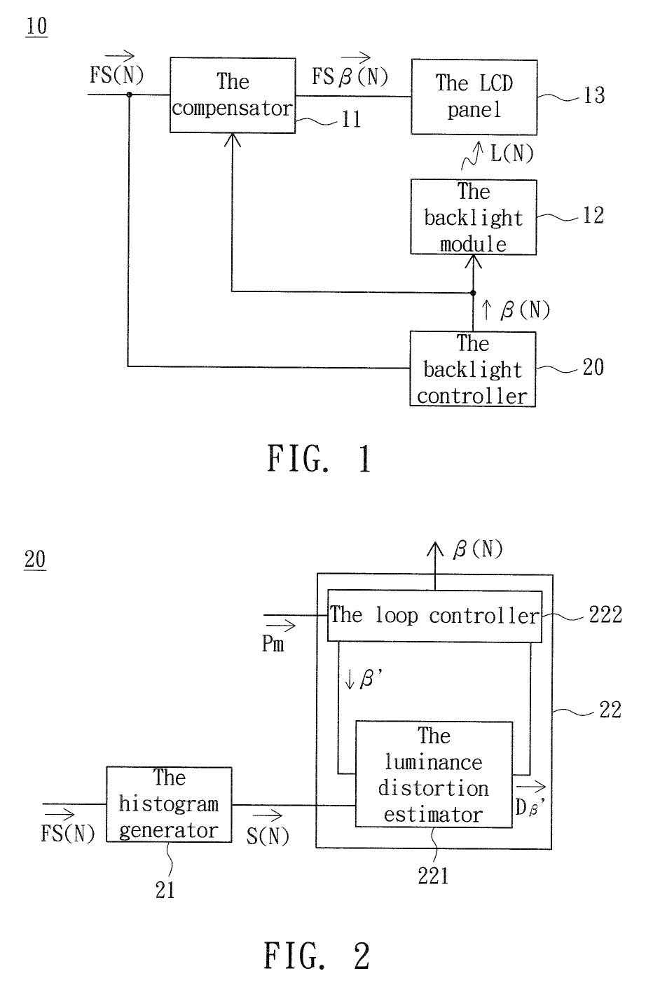

Referring to FIG. 1, a block diagram of a LCD using a backlight controller according to a first embodiment of the invention is shown. The liquid crystal display (LCD) 10 includes a compensator 11, a backlight module 12, an LCD panel 13 and a backlight controller 20. The backlight controller 20 generates a scaling factor β (N) in response to a frame signal FS (N) of an N-th frame, and outputs the scaling factor β (N) to the compensator 11 and the backlight module 12. The backlight module 12 reduces the original backlight luminance in response to the scaling factor β (N) to generate a scaled backlight Lβ (N), N is a natural number.

A frame signal FS (N) is received by the compensator 11 for compensating the frame signal FS (N) in response to the scaling factor β (N) to output a frame signal FSβ (N) to an LCD panel 13. The LCD panel 13 displays a frame in response to the frame signal FSβ (N).

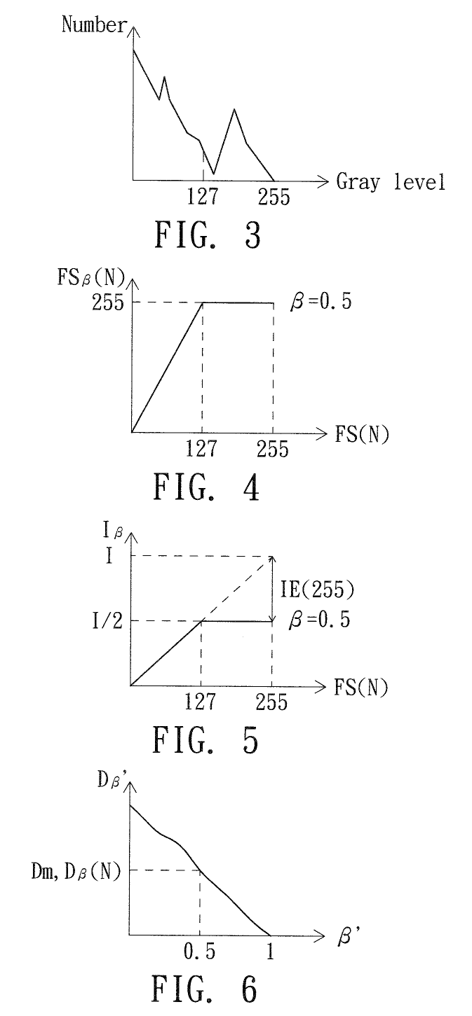

Referring to FIG. 2, a block diagram of a backlight controller according to a first embodiment of the invention is shown. The backlight controller 20 includes a histogram generator 21 and a scaling factor selector 22. The histogram generator 21 receives the frame signal FS (N), and calculates the pixel grey level thereof to generate a histogram S (N) as indicated in FIG. 3, wherein the histogram of the pixel grey level of the frame signal FS (N) ranging 0˜255 are included. In the present embodiment of the invention, the pixel data includes 8 bits, and the pixel grey level has a numeric region of 0˜255.

The scaling factor selector 22 includes a luminance distortion estimator 221 and a loop controller 222. The luminance distortion estimator 221 estimates a distortion Dβ′ corresponding to a candidate scaling factor β′ with reference to the histogram S (N), wherein the candidate scaling factor β′ is a real number larger than or equal to 0, and smaller than or equal to 1. The loop controller 222 selects a scaling factor β (N) in response to the distortion Dβ′ and an error signal Dm, and outputs the selected scaling factor β (N) to the backlight module 12 and the compensator 11. The scaling factor β (N) is corresponding to the error signal Dm that, for example, is a maximum acceptable distortion of the distortion Dβ′.

The backlight module 12 of the present embodiment of the invention controls the luminance of the scaled backlight Lβ (N) to be equal to the product of the luminance of the original backlight and the scaling factor β (N). For example, when the scaling factor β (N) is equal to 0.5, the luminance of the scaled backlight Lβ (N) is substantially equal to a half of the luminance of the original backlight.

The compensator 11 adjusts the frame signal FS (N) according to the equation: FSβ (N)=FS (N)/β (N), wherein a correspondence curve of pixel grey level between frame signals FS (N) and FSβ (N) is shown in FIG. 4. In FIG. 4, the scaling factor β (N) is equal to 0.5, but each pixel grey level of the frame signal FSβ (N) is substantially equal to a double of the pixel data FS (N). Thus, when the luminance of the scaled backlight Lβ (N) of the backlight module 12 is reduced to a half of the original backlight, the frame signal FSβ (N) is increased to be a double of the frame signal FS (N) so as to correct the frame.

Thus, when a dark or black frame is to be displayed on the LCD 10, the backlight controller 20 of the present embodiment of the invention can effectively generate a corresponding scaling factor β (N) to reduce the luminance of the scaled backlight Lβ (N) of the backlight module 12. Thus, the LCD 10 of the present embodiment of the invention effectively overcomes the disadvantages of a conventional LCD backlight module, such as consuming more power, and having shorter lifespan, lower contrast ratio when displaying dark or black image frame, and poor display quality.

As indicated in FIG. 4, the pixel data whose grey levels of the frame signal FS (N) are larger than 127 can only be corrected to be 255 in the frame signal F Sβ (N), not doubled. Thus, a luminance error IE (K) will occur when displaying the pixels, wherein K is larger than or equal to 128, and is smaller than or equal to 255. The correspondence between pixel grey level of the frame signal FS (N) of FIG. 1 and corresponding luminance error IE (K) is shown in FIG. 5.

The luminance distortion estimator 221 of the present embodiment of the invention accumulates each grey level of the frame signal FS (N) and its corresponding luminance error IE (K) with reference to the histogram S (N) to obtain a distortion Dβ (N) corresponding to the scaling factor β (N) and the frame signal FS (N), wherein a correspondence curve between distortion Dβ′ and candidate scaling factor β′ is shown in FIG. 6.

The loop controller 222 of the present embodiment of the invention provides all candidate scaling factor β′ ranging between 0˜1 to the luminance distortion estimator 221 by the full range search method to search for the corresponding distortion Dβ′. Afterwards, the loop controller 222 finds out the scaling factor β (N) and the distortion Dβ (N) in response to the error signal Dm.

Thus, the backlight controller 10 of the present embodiment of the invention can receive the error signal Dm, that is, the maximum acceptable distortion of the distortion Dβ′, via the loop controller 222, and accordingly selects a scaling factor β (N) among the candidate scaling factors β′ to reduce the luminance of the original backlight. By doing so, the backlight controller 10 of the present embodiment of the invention has the advantage of setting an upper limit to the luminance error in the frame image with reference to the error signal Dm to reduce the luminance error in the frame image of the LCD 10.

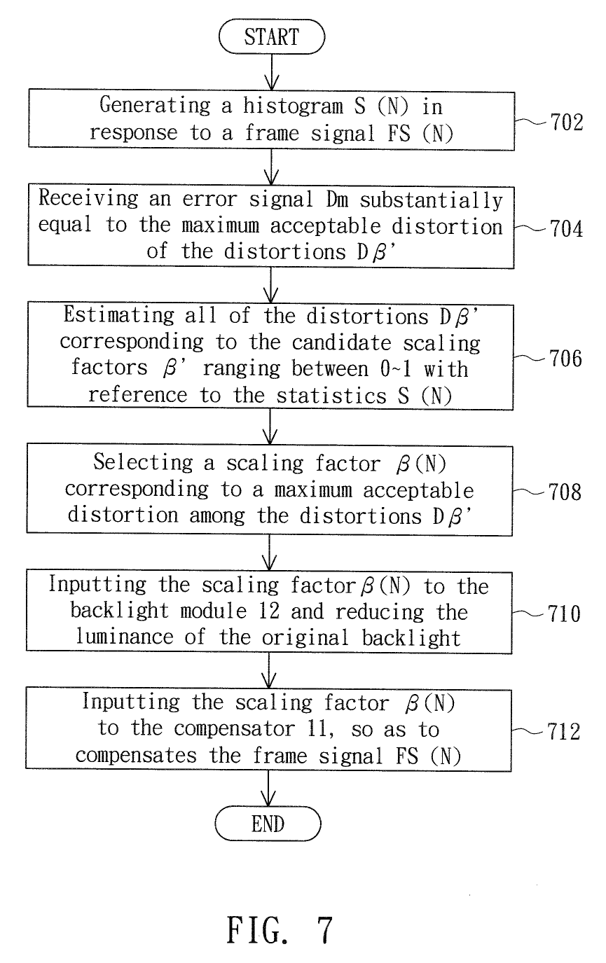

Referring to FIG. 7, a flowchart of full range search method for searching a scaling factor β (N) according to a first embodiment of the invention is shown. Firstly, the method begins at step 702, a histogram S (N) is generated by the histogram generator 21 in response to a frame signal FS (N). Next, the method proceeds to step 704, an error signal Dm substantially equal to the maximum acceptable distortion of the distortions Dβ′ is received by the loop controller 222.

Then, the method proceeds to step 706, all of the distortions Dβ′ corresponding to the candidate scaling factors β′ ranging between 0˜1 are estimated with reference to the histogram S (N). Afterwards, the method proceeds to step 708, a scaling factor β (N) is selected among the candidate scaling factors β′ by the loop controller 222, wherein the scaling factor β (N) corresponds to the maximum distortion of all of the distortions Dβ′ smaller than or equal to the error signal Dm. In the present invention, the scaling factor β (N) corresponds to the distortions Dβ′ equal to the error signal Dm, which is substantially the maximum acceptable distortion.

Then, the method proceeds to step 710, the scaling factor β (N) is outputted to the backlight module 12 by the loop controller 222, and the original backlight is reduced to the scaled backlight Lβ (N), wherein the luminance of the scaled backlight Lβ (N) is substantially equal to the product of the luminance of the original backlight and the scaling factor β (N). Afterwards, the method proceeds to step 712, scaling factor β (N) is outputted to the compensator 11 by the loop controller 222. The compensator 11 compensates the frame signal FS (N) and accordingly outputs a frame signal FSβ (N) to the LCD panel 13 to display a frame image.

The backlight controller of the present embodiment of the invention calculates all pixel grey levels of a frame signal, and obtains all of the distortions corresponding to candidate scaling factors with reference to the histogram. The backlight controller of the present embodiment of the invention further receives a maximum acceptable distortion of the distortions, and accordingly selects a better scaling factor referencing the luminance distortions. Thus, the backlight controller of the present embodiment of the invention effectively overcomes the disadvantages of a conventional LCD backlight module, such as more power consumption, and shorter lifespan, lower contrast ratio when displaying darker colors, and poor display quality, and makes the backlight module using the backlight controller of the invention have lower power consumption, longer life-span, better LCD contrast ratio and better quality of frame image.

Moreover, the backlight controller of the present embodiment of the invention can further set an upper limit with reference to an error signal to the luminance error in the frame image of the LCD of the present embodiment of the invention. By doing so, the LCD using the backlight controller of the present embodiment of the invention is further advantaged by a lower luminance error in the frame image.

### Second Embodiment

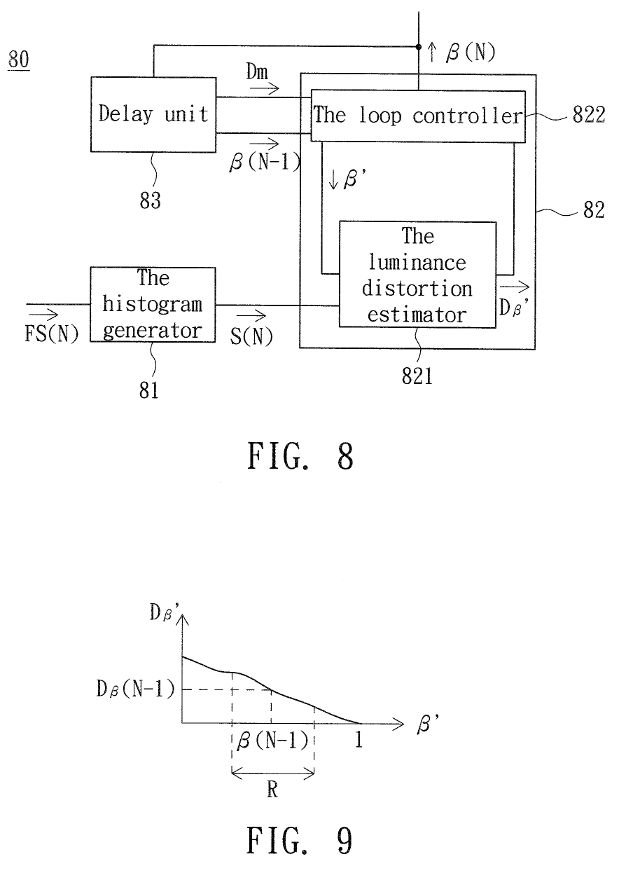

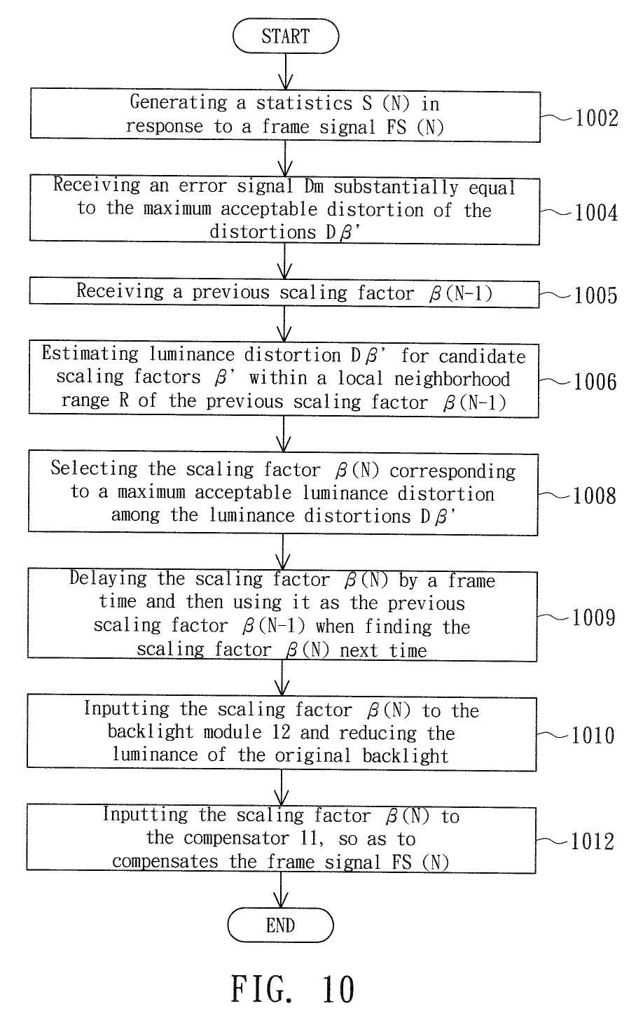

Referring to FIG. 8, a block diagram of a backlight controller according to a second embodiment of the invention is shown. The backlight controller 80 of the present embodiment of the invention differs with the backlight controller 20 of the first embodiment of the invention in that the backlight controller 80 further includes a delay unit 83. The delay unit 83 receives and delays the frame time of a scaling factor β (N), and then outputs the delayed scaling factor β (N). The loop controller 822 of the present embodiment of the invention differs with the loop controller 222 of the first embodiment of the invention in that the loop controller 822, by way of a local range search method for example, uses all the numeric numbers within a numeric region R of the previous scaling factor β (N−1) as candidate scaling factors β′, and find out a scaling factor β (N) among the candidate scaling factors β′. The relation between the numeric region R and previous scaling factor β (N−1) is shown in FIG. 9.

Referring to FIG. 10, a flowchart of local range search method for searching a scaling factor β (N) according to a second embodiment of the invention is shown. The local range search method of the present embodiment of the invention scaling factor β (N) differs with the full range search method of the first embodiment of the invention in that before step 706, the local range search method further includes step 1005 and step 1006. In step 1005, previous scaling factor β (N−1) is provided to the loop controller 822 by the delay unit 83. In step 1006, the loop controller 822 uses all the numeric numbers within a numeric region R near the previous scaling factor β (N−1) as the candidate scaling factors β′, and finds out a corresponding distortion Dβ′ from the candidate scaling factors β′. After step 708, the local range search method further includes step 1009, a scaling factor β (N) is received, delayed and outputted by the delay unit 83, and the delayed scaling factor β (N) is used as a previous scaling factor β (N−1) when finding the scaling factor β (N) next time.

In the present embodiment of the invention, the scaling factor β (N) is searched by the loop controller 822 according to the local range search method. However, the loop controller 822 can select a scaling factor β (N) among the scandidate scaling factors β′ according to other methods. For example, the binary search method is used to find out a scaling factor β (N) within the numeric region R.

In most cases, the luminance levels in two subsequent frame images are substantially the same, so that the numeric numbers of scaling factors β (N−1) and β (N) of two subsequent frame images are also very close. Thus, the backlight controller 80 of the present embodiment of the invention can effectively find out the scaling factor β (N) within the numeric region R near the scaling factor β (N−1) of previous frame image by local range search. Thus, apart from the advantages that the backlight module has lower power consumption, longer life-span, better LCD contrast ratio and better quality of frame image, the backlight controller of the present embodiment of the invention is further advantaged by saving the operation resources for the loop controller in searching the scaling factor.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A backlight controller scaling the intensity of a backlight illuminating a liquid crystal display (LCD), comprising:
a histogram generator generating a histogram for an input frame signal of the LCD; and
a scaling factor selector, comprising:
a luminance distortion estimator estimating a luminance distortion for each candidate scaling factor based on the histogram; and
a loop controller selecting a scaling factor corresponding to a maximum acceptable distortion among the estimated luminance distortions, so as to scale the intensity of the backlight.

2. The backlight controller according to claim 1, wherein the candidate scaling factor is within a global upper boundary and a global lower boundary of the scaling factor.

3. The backlight controller according to claim 1, further comprising:
a delay unit used for receiving a previous scaling factor and inputting the previous scaling factor to the loop controller, wherein the scaling factor selector obtains the scaling factor according to the previous scaling factor.

4. The backlight controller according to claim 3, wherein the candidate scaling factor is within a local neighborhood range around the previous scaling factor.

5. The backlight controller according to claim 1, the scaling factor further used for compensating the gray levels of the pixel signals of the input frame signal corresponding to the input frame signal.

6. A scaling factor full range search method for searching a scaling factor scaling the intensity of a backlight iluminating a liquid crystal display (LCD), comprising the following steps of:
generating a histogram for an input frame signal of the liquid crystal display;
estimating luminance distortions for candidate scaling factors between an global upper boundary and a global lower boundary of the scaling factor based on the histogram;
selecting the scaling factor corresponding to a maximum acceptable luminance distortion among the luminance distortions; and
scaling the intensity of the backlight according to the scaling factor.

7. The full range search method according to claim 6, further comprising:
compensating the gray levels of the pixel signals of the input frame singnal according to the scaling factor.

8. The full range search method according to claim 6, further comprising:
receiving the maximum acceptable liminance distortion.

9. A scaling factor local range search method for searching a scaling factor scaling the intensity of a backlight iluminating a liquid crystal display (LCD), comprises the following steps of:
generating a histogram for an input frame signal of the LCD;
receiving a previous scaling factor;
estimating luminance distortions for candidate scaling factors within a local neighborhood range of the previous scaling factor; and
selecting the scaling factor corresponding to a maximum acceptable luminance distortion among the luminance distortions; and
scaling the intensity of the backlight according to the scaling factor.

10. The local range search method according to claim 9, further comprising:
delaying the scaling factor by a frame time and then using the scaling factor as the previous scaling factor.

11. The local range search method according to claim 9, further comprising:
compensating the input frame singnal according to the scaling factor.

12. The local range search method according to claim 9, further comprising:
receiving the maximum acceptable liminance distortion.

13. The local range search method according to claim 9, wherein the step of selecting the scaling factor corresponding to the amximum acceptable luminance distortion is achieved by binary search method.
